(19) United States
(12) Patent Application Publication
(10) Pub. No.: US 2026/0278947 A1
(43) Pub. Date: Sep. 17, 2026

(54) INTERACTIVE DIGITAL TWIN WITH DATA INTEGRATION

(71) Applicant: Intuitive Research and Technology Corporation, Huntsville, AL (US)

(72) Inventors: Steven Michael Thomas, Madison, AL (US); Olivia Weaver, Madison, AL (US); Jason L. Rogers, Meridianville, AL (US); Harleigh Bass, Huntsville, AL (US); Andrew Zelinka, Hunstville, AL (US); Angel Reinaldo Almodóvar, Huntsville, AL (US)

(21) Appl. No.: 19/076,129

(22) Filed: Mar. 11, 2025

Related U.S. Application Data
(60) Provisional application No. 63/564,304, filed on Mar. 12, 2024.

(51) Int. Cl. G06T 19/00; G06F 3/04842

(52) U.S. Cl. CPC G06T 19/003; G06F 3/04842

(57) ABSTRACT

A system is configurable to: (i) present a visual representation of a physical system that comprises a plurality of physical components, wherein the visual representation comprises a plurality of 2D or 3D components that each correspond to a respective physical component of the plurality of physical components of the physical system; (ii) present a model-based systems engineering (MBSE) hierarchy representation that comprises a plurality of labels and a relational structure indicating one or more relationships among the labels defined by MBSE artifacts of an MBSE model of the physical system, wherein each label corresponds to a respective 2D or 3D component of the visual representation of the physical system; (iii) receive user input directed to a particular label that corresponds to a particular 2D or 3D component; and (iv) navigate to and visually emphasize the particular 2D or 3D component within the presentation of the visual representation.

### CROSS-REFERENCE TO RELATED APPLICATIONS

This application claims priority to and the benefit of U.S. Provisional Application No. 63/564,304, filed on Mar. 12, 2024, and entitled “INTERACTIVE DIGITAL TWIN WITH DATA INTEGRATION”, the entirety of which is incorporated herein by reference for all purposes.

### BACKGROUND

Systems engineering is an approach for the development of complex systems. Systems engineering can integrate different disciplines and/or specialty groups to form a structured development process that proceeds from conception to production and to operation. Systems engineering can consider technical (and business) needs or requirements of a customer to facilitate creation of a system/product that fulfills such requirements. Systems engineering is often used in the creation of complex systems such as aircraft, vehicles, computer networks, infrastructures, etc.

Traditional systems engineering approaches have been document-based, relying heavily on written specifications, manuals, and diagrams to communicate the requirements, design, and operation of a system. Such traditional approaches typically follow a linear process, where each phase of the system's lifecycle is completed before the next one begins, including concept development, system definition, design and development, integration and testing, deployment, and maintenance. Each phase can involve a series of reviews and revisions, resulting in the generation of detailed documents at each phase to ensure that all requirements are met and that the system as a whole functions as desired.

Model-based systems engineering (MBSE) has emerged as an approach to systems engineering. MBSE uses models as a primary means of information exchange (e.g., rather than relying primarily on text-based documents as in traditional systems engineering methods). MBSE models can provide a visual and/or analytical representation of a system, capturing the necessary details to understand, design, verify, and validate the system throughout its entire lifecycle. Standardized system modeling languages such as SysML (Systems Modeling Language) have been developed to facilitate efficient and effective representation of system architectures, behaviors, and requirements.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates example components of a system that may comprise or implement the disclosed embodiments.

FIG. 2 illustrates a diagram showing elements associated with an interactive digital twin with integrated data.

FIG. 3A illustrates an example user interface display that presents a 3D representation of a physical system.

FIG. 3B illustrates an example user interface display that presents component details for a selected component in conjunction with a 3D representation of the component and the overall physical system.

FIG. 3C illustrates an example user interface display that presents an inspection view of a selected 3D component of a 3D representation of a physical system.

FIG. 3D illustrates an example user interface display showing a split view of a 3D representation of a physical system.

FIGS. 3E and 3F illustrate example component search functionality of an example user interface display showing a visual representation of a physical system.

FIGS. 3G, 3H, and 3I illustrate an example user interface display showing MBSE hierarchy information associated with a physical system and/or components thereof in conjunction with a 3D representation of the physical system.

FIGS. 3J and 3K illustrate an example user interface display showing MBSE requirements information associated with a physical system and/or components thereof in conjunction with a 3D representation of the physical system.

FIGS. 4A and 4B illustrate an example user interface display showing a maintenance interface associated with one or more deployed physical systems.

### DETAILED DESCRIPTION

Disclosed embodiments are directed to systems, methods, apparatuses, and techniques associated with interactive digital twins with data integration.

As noted above, MBSE has emerged as an approach to systems engineering that uses models as a key means of information exchange. MBSE can address various shortcomings associated with conventional systems engineering approaches by improving communication among stakeholders, improving clarity by utilizing a single model to represent the system, reducing errors and/or redesigns, etc.

Although MBSE can help to address such shortcomings, various challenges exist within the domain of MBSE. For example, system models created under MBSE techniques can be highly detailed and complex. Although this can be desirable for the design and analysis process, such representations can be overwhelming for those not familiar with the modeling language used or the principles of systems engineering. For instance, executives and managers often need information that is directly relevant to decision-making processes, such as high-level system functionalities, cost implications, risk assessments, etc. Extracting such information from highly detailed and complex system models can be an obstacle for executives, managers, and other stakeholders, especially those that lack familiarity with system modeling languages or MBSE system model analysis.

At least some disclosed embodiments are directed to constructing and presenting aspects of an interactive digital twin of a physical system that integrates MBSE data. For instance, disclosed techniques can involve generating or accessing a 3D representation of a physical system that includes 3D components corresponding to respective physical components of the physical system. The 3D representation can comprise a 3D model of the physical system and/or its components (e.g., as 3D model used in the manufacture of the physical system and/or its components, or a 3D model constructed based on a physical/tangible instance of the physical system).

Disclosed techniques can also involve extracting information from a system model for the physical system and integrating (or correlating or associating) the extracted information with the 3D components of the 3D representation. The system model can include structural diagrams, behavioral models (e.g., state machine diagrams, sequence diagrams, activity diagrams), requirements information, parametric models, simulations, and/or other system modeling artifacts. The system model can be built using typical MBSE processes (e.g., determining high-level context, requirements, capabilities, boundaries, for the physical system; determining operational level system behavior and connectivity; determining component-level structure/parameters for the physical system and component-level behavior, connectivity, and logical architecture; etc.). For instance, the system model can be developed using SysML, UML (unified modeling language), AADL (architecture analysis and design language), and/or other modeling languages via one or more software suites that support such languages (e.g., CAMEO, RHAPSODY, ENTERPRISE ARCHITECT, CAPELLA, and/or others). For example, the system model can comprise a modeling file or a model export (e.g., HTML export) associated with an appropriate MBSE software suite.

The extracted information from the system model can indicate relationships (e.g., interconnectivity, hierarchical level, parent-child relationships, sibling relationships, etc.) among the physical components of the physical system that correspond to the 3D components of the 3D representation. The extracted information can additionally include component-specific implementation details, such as component title, hardware specifications, model numbers, manufacturers, operational parameters/capabilities, handling or installation instructions or information, cost, maintenance information, etc.

The integration of the component-specific extracted data/information from the system model with the 3D components of the 3D representation can enable the 3D components to be displayed in conjunction with MBSE hierarchy representations. The MBSE hierarchy representations can communicate system model information in an intuitive, readily understandable manner. For instance, disclosed techniques can involve presenting the 3D representation on a user interface and receiving user input directed to a particular 3D component of the 3D representation. In response to the user input, a MBSE hierarchy representation may be presented or surfaced on the user interface in addition to the 3D representation. The MBSE hierarchy representation can include labels (e.g., list items, tiles, cards, panels, boxes, thumbnails, icons, etc.) corresponding to 3D components of the 3D representation, including a particular label for the particular 3D representation selected via user input. For instance, a label can comprise a name of its corresponding 3D component (or the name of the physical component of the physical system associated with the 3D component).

After receiving the aforementioned user input directed to the particular 3D component of the 3D representation, the MBSE hierarchy representation can depict the particular label in an emphasized form (e.g., bolding label text, changing label color, label enlarging or shrinking, etc.). Furthermore, the 3D representation can be modified to depict the particular 3D component in emphasized form (e.g., component outlining, component color or material changing, component isolation, etc.). The MBSE hierarchy representation can depict the various labels thereof with a relational structure that indicates relationships among the labels (and correspondingly indicates relationships among the 3D/physical components associated with the labels). The relational structure can take on various forms, such as visual links (e.g., arrows or lines) connecting the labels to other labels with which they are related (e.g., parent-child relationships, sibling relationships, etc.).

In some implementations, a user interacting with the user interface can view the 3D representation and 3D components thereof from different perspectives, orientations, zoom levels, etc., by navigating a virtual camera about the 3D representation (e.g., within a 3D virtual environment or partially virtual environment, such as an augmented reality environment). The user can additionally direct user input to different 3D components of the 3D representation, causing emphasis of different labels within the MBSE hierarchy representation and/or emphasis of different 3D components of the 3D representation.

In some instances, selecting a different 3D component (e.g., part of a different subsystem or assembly than a previously selected 3D component) causes presentation of a different MBSE hierarchy representation that includes a different subset of labels (associated with at least some different 3D/physical components) than an initially presented MBSE hierarchy representation. Such functionality can improve user interpretability of the MBSE hierarchy representations (e.g., by only including, in each MBSE hierarchy representation, labels determined to be relevant to the selected 3D component, or determined to be related to the same next-higher assembly (NHA)). In this regard, multiple MBSE hierarchy representations may be constructed based on a system model for a physical component, and the MBSE hierarchy representation queued for display on a user interface may be dynamically selected based on the 3D component selected via user input.

Furthermore, in some instances, a MBSE hierarchy representation generated based on a system model for a physical system can include a set of one or more labels that do not correspond to a 3D component of the 3D representation. For instance, the set of labels can correspond to intangible components of the physical system (e.g., components that are not associated with a respective human-discernible physical artifact), such as software or logical components or processes of the physical system (the intangible components may be represented in the system model of the physical system). The relational structure of a MBSE hierarchy representation can indicate relationships between the set of labels (associated with intangible components) and other labels that have corresponding physical components in the 3D representation, which can indicate reliance or interoperation of intangible components with tangible physical components.

A MBSE hierarchy representation can additionally or alternatively include labels associated with physical components that have no corresponding 3D component in the 3D representation to illustrate relationships among the (labels of the) 3D components shown in the 3D representation and other physical components omitted from the 3D representation. For instance, labels may be included in the MBSE hierarchy representation that relate to physical components of the same physical system as other 3D components shown in the 3D representation, or that relate to a different physical system altogether. 3D components can be omitted from the 3D representation (but still have a corresponding label in the MBSE hierarchy representation) for various purposes, such as permissions, confidentiality or security constraints, or incompleteness in the MBSE model 208.

Implementing the techniques and/or principles disclosed herein can provide a digital representation of an intended or real-world physical product or system that couples MBSE information (e.g., system model information) with a 3D representation of the physical product or system. Such functionality can enable inspection of the digital representation of the physical system from multiple angles and can enable component isolation to provide a better understanding of physical relationships among the components of the physical system. Implementing the disclosed principles can enable various stakeholders (e.g., project managers, chief engineers, executives) to achieve streamlined or accelerated analysis of system-level data in a targeted, intuitive manner, which can enhance comprehension of present or future behaviors and/or performance of the underlying physical system. Such information can enable stakeholders to make more informed program decisions. For instance, displaying an interactive digital twin with integrated data as described herein can enable users to analyze potential effects of changing system requirements late in a project life cycle. Implementing the disclosed embodiments can help to bridge the communication gap between technical teams who develop and understand the MBSE models and the non-technical stakeholders who need to use information contained in models for strategic planning and/or decision-making purposes.

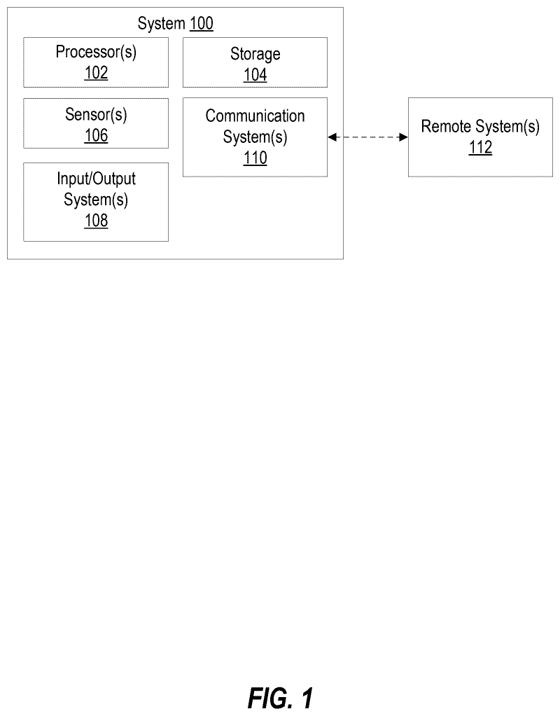

FIG. 1 illustrates various example components of the system 100. For example, FIG. 1 illustrates an implementation in which the system includes processor(s) 102, storage 104, sensor(s) 106, I/O system(s) 108, and communication system(s) 110. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise computer-readable recording media and may be volatile, non-volatile, or some combination thereof. Furthermore, storage 104 may comprise local storage, remote storage (e.g., accessible via communication system(s) 110 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions stored within storage 104 to perform certain actions. The actions may rely at least in part on data stored on storage 104 in a volatile or non-volatile manner. In some instances, the actions may rely at least in part on communication system(s) 110 for receiving data from remote system(s) 112, which may include, for example, separate systems or computing devices, sensors, and/or others. The communications system(s) 110 may comprise any combination of software or hardware components that are operable to facilitate communication between on-system components/devices and/or with off-system components/devices. For example, the communications system(s) 110 may comprise ports, buses, or other physical connection apparatuses for communicating with other devices/components. Additionally, or alternatively, the communications system(s) 110 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 106. Sensor(s) 106 may comprise any device for capturing or measuring data representative of perceivable phenomena. By way of non-limiting example, the sensor(s) 106 may comprise one or more image sensors, microphones, thermometers, barometers, magnetometers, accelerometers, gyroscopes, and/or others. For example, the sensor(s) 106 may include inertial measurement unit(s) (IMU(s)), which may comprise any number of accelerometers, gyroscopes, and/or magnetometers to capture motion data associated with the system 100 as the system moves within physical space. The motion data may comprise or be used to generate pose data, which may describe the position and/or orientation (e.g., 6 degrees of freedom pose) and/or change of position (e.g., velocity and/or acceleration) and/or change of orientation (e.g., angular velocity and/or angular acceleration) of the system 100. The pose data may be used to facilitate extended reality experiences.

Furthermore, FIG. 1 illustrates that a system 100 may comprise or be in communication with I/O system(s) 108. I/O system(s) 108 may include any type of input or output device such as, by way of non-limiting example, a touch screen, a mouse, a keyboard, a controller, and/or others, without limitation. For example, the I/O system(s) 108 may include a display system that may comprise any number of display panels or screens, projectors, optics, laser scanning display assemblies, and/or other components.

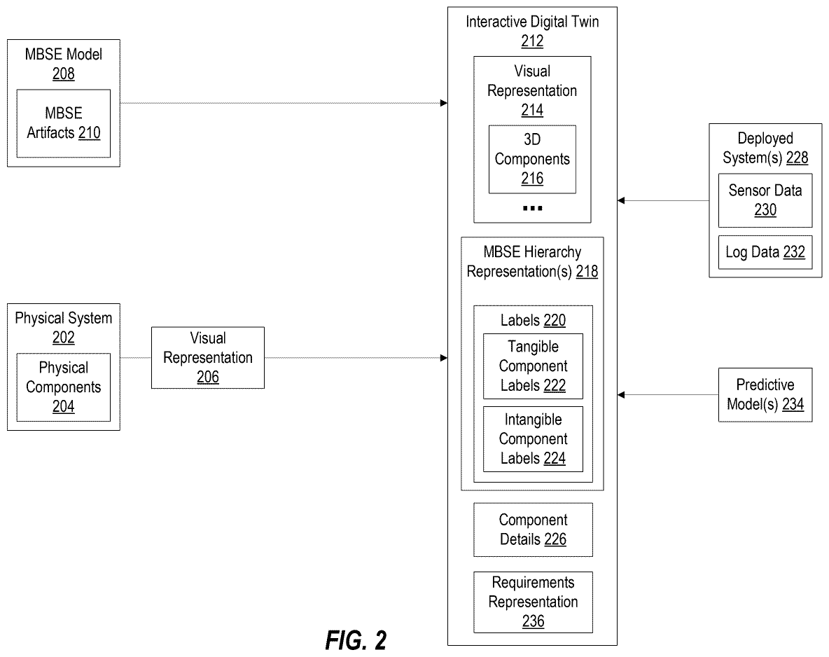

FIG. 2 illustrates a diagram showing elements associated with an interactive digital twin with integrated data, according to the subject matter of the present disclosure. FIG. 2 shows a conceptual representation of a physical system 202, which can include physical components 204 that are interconnected or that interoperate with one another. The physical system 202 can correspond to any system, device, or product that includes tangible components, such as an aerospace system, a defense system, an automotive system, a rail system, a maritime system, a telecommunication network/system, an energy system, a healthcare system, an environmental or geospatial system, an industrial system, a manufacturing system, a consumer electronic system, a safety or security system, a transportation system, and/or others.

FIG. 2 also depicts a visual representation 206 of the physical system 202. In some implementations, the visual representation 206 comprises one or more 3D models of the physical system 202, which can include subsidiary 3D models depicting at least some of the physical components 204 of the physical system 202. The 3D model(s) of the physical system 202 can be generated in various ways, such as via computer-assisted modeling (e.g., CAD modeling, parametric modeling, etc.), 3D scanning/reconstruction, combinations thereof, and/or other methods. The visual representation 206 may represent the physical system 202 whether manufacturing/production of the physical system 202 and/or specific physical components 204 thereof has occurred or not.

In some implementations, the visual representation 206 of the physical system 202 comprises non-3D representations thereof, such as 2D views/drawings or diagrams (e.g., blueprints, engineering or technical drawings, etc.). In some implementations, the visual representation 206 visually depicts one or more aspects of processes/operations performed or products generated/created by the physical system 202.

The physical system 202 may be engineered or modeled in accordance with MBSE principles, as described herein. FIG. 2 depicts a conceptual representation of a MBSE model 208 associated with the physical system 202. The MBSE model 208 may be developed via MBSE methods, such as, by way of non-limiting example, defining system requirements and objectives, developing conceptual models, using MBSE tools and frameworks to create the detailed system models, and analyzing, simulating, and validating the system models. The MBSE model 208 may include MBSE artifacts 210 that represent various aspects of the physical system 202 at any stage of a project lifecycle. The MBSE artifacts 210 can include, for instance, structural diagrams, state machine diagrams, sequence diagrams, activity diagrams, requirements information, parametric models, and/or other system modeling components/information. The MBSE model 208 and/or the MBSE artifacts 210 thereof may be represented in various ways, such as one or more modeling files or exports (e.g., HTML exports) associated with or generated via an MBSE software suite.

FIG. 2 illustrates an interactive digital twin 212, which can be generated based on the visual representation 206 (e.g., including one or more 3D models) and the MBSE artifacts 210 of the MBSE model 208 (indicated in FIG. 2 by the arrows extending from the visual representation 206 and the MBSE model 208 to the interactive digital twin 212). The interactive digital twin 212 can comprise a software application, service, utility, package, platform, tool, or component that can provide a visual representation of the physical system 202 in a manner that integrates MBSE components/data from the MBSE model 208. The interactive digital twin 212 can be implemented on a user device (e.g., system 100), and aspects thereof can be presented on a user interface to provide users with an interactive experience that conveys system-level data/information for the physical system 202 in conjunction with a visual representation of physical components 204 of the physical system 202.

As shown in FIG. 2, the interactive digital twin 212 can include various elements, such as a visual representation 214 of the physical system 202, which can comprise or be generated based on the visual representation 206 noted above. The visual representation 214 can include 3D components 216 that correspond to (or represent) physical components 204 of the physical system 202. As will be described in more detail hereinafter, the 3D components 216 of the visual representation 214 can be displayed on a user interface to convey visual information about the physical components 204 of the physical system 202 to users.

The ellipsis shown in FIG. 2 within the visual representation 214 indicates that the visual representation 214 can include additional or alternative types of visualizations, such as 2D drawings/diagrams (and corresponding 2D components associated with different, respective physical components 204 and/or intangible components of the physical system 202 and/or MBSE model 208), output of models/simulations, etc. In some implementations, where the visual representation 214 comprises output of one or more models or simulations (e.g., predictive model(s) 234), the model(s) or simulation(s) may generate one or more quantitative or qualitative aspects of processes/operations performed (e.g., manufacturing/production operations) or products generated/created by the physical system 202 based on the configuration of the MBSE model 208 defined by the MBSE artifacts 210. The output of the model(s) and/or the simulations may be updated or re-generated in real-time or near-real-time based on user modifications to the MBSE hierarchy representation(s) 218 and/or the requirements representation 236 associated with MBSE artifacts 210, which can enable users to explore downstream effects of modifications to the structure, components, parameters, operations, or interoperations of the physical system 202. By way of illustrative example, where the physical system 202 comprises a production or manufacturing system with characteristics defined by the MBSE artifacts 210, the visual representation 214 can include depictions of metrics generated by one or more simulations/models indicating production lead times, facility/capital infrastructure costs and/or implications, and/or supply chain resiliency. These metrics can be dynamically updated by the simulation(s)/model(s) based on user modifications to representations of the physical components 204 and/or MBSE artifacts 210 provided by the interactive digital twin 212 (e.g., in the visual representation 214, the MBSE hierarchy representation(s) 218, the requirements representation 236, the component details 226), allowing the user to perceive the effect of changes to the structure of the MBSE model 208 associated with the physical system 202.

As also shown in FIG. 2, the interactive digital twin 212 can include one or more MBSE hierarchy representations 218 (or system model hierarchy representations), which can be used to convey information about relationships between or among the physical components 204 (and/or intangible components) of the physical system 202 as represented in the MBSE artifacts 210 of the MBSE model 208. The MBSE hierarchy representation(s) 218 can be generated based on the MBSE artifacts 210 of the MBSE model 208. The MBSE hierarchy representation(s) 218 can be presented on a user interface in conjunction with 3D components 216 (and/or other components) of the visual representation 214 to simultaneously provide users with system-level MBSE information/data and visual depictions of the components referenced in the system-level MBSE information/data. Such functionality can assist non-technical users in understanding system information from the MBSE model 208.

In the example of FIG. 2, the MBSE hierarchy representation(s) 218 include(s) labels 220, which may be presented on a user interface in conjunction with the visual representation 214 (or 3D components 216 thereof). The labels 220 can include tangible component labels 222, at least some of which may correspond to (or represent) a respective 3D component 216 (or 2D component) of the visual representation 214. In some instances, one or more of the tangible component labels 222 may correspond to (or represent) a physical component of the physical system 202 (or another system) for which no corresponding 3D component 216 of the visual representation 214 exists.

Additionally, in some instances, the labels 220 can include intangible component labels 224 that represent intangible components defined in the MBSE model 208 (e.g., software, firmware, data/information, protocols, standards, user interfaces/experiences, services/processes, logical components, system behaviors). The intangible components can interact with or rely on one or more physical components 204 of the physical system 202.

The labels 220 can include or be presented with identifying information (e.g., text, thumbnail graphics, etc.) to assist users in understanding the correspondence between the labels 220 and the 3D components 216 (and/or 2D components) of the visual representation 214. As will be described in more detail hereinafter, the labels 220 may be presented on a user interface using a relational structure that indicates the relationships between or among the tangible physical components 204 and intangible components associated with the labels 220, as defined by the MBSE artifacts 210 of the MBSE model 208.

The interactive digital twin 212 can additionally include component details 226 for the various components of the physical system 202 represented by the labels 220. Similar to the labels 220, the component details 226 may be presented on a user interface in conjunction with the visual representation 214 (or 3D components 216 and/or 2D components thereof). The component details 226 can include various information for the physical components 204 corresponding to the 3D components 216 (or 2D components) of the interactive digital twin 212, such as the title of the component, the system type or next-higher assembly of which the component is a part, the manufacturer of the component, the model number of the component, modeling and simulation information for the component, a technical data package for the component, specifications or operational parameters/constraints for the component, testing information and/or results for the component, configuration management information for the component, analysis of alternatives (AoAs) data for the component, assembly or installation or deployment information (e.g., instructions, diagrams, tables, procedures, supplies/parts), additional representations of the component (e.g., models, animations, drawings), maintenance information (e.g., required maintenance events, timelines, instructions, procedures, supplies/parts), and/or other characteristics of the component (e.g., states, state variables, remaining lifespan, cost, weight, operational parameters, values, settings, or ranges, etc.). The component details 226 can be determined based on the MBSE artifacts 210 of the MBSE model 208. In some instances, one or more of the component details 226 are determined based on sensor data 230 and/or log data 232 associated with one or more deployed systems 228 (described in more detail hereinafter) and/or based on output of one or more predictive models 234 (or simulation models).

In some implementations, the interactive digital twin 212 further includes a requirements representation 236, which can visually represent requirements represented in the MBSE model 208 or MBSE artifacts 210. The requirements of the MBSE model 208 can define what a system will accomplish, the constraints it will operate within, and how it should perform its intended functions. The requirements can serve as a foundation for design, implementation, testing, and lifecycle management, enabling stakeholders to have a clear and structured understanding of what will be achieved. The requirements represented in the requirements representation 236 can be organized into categories of requirements, such as development requirements, test and evaluation requirements, sustainment requirements, and collaboration requirements.

Development requirements can specify the capabilities, features, and constraints that the system associated with the MBSE model 208 should meet during design and production. Development requirements can guide engineers in shaping the system architecture, selecting materials, and determining performance metrics. Development requirements can include functional requirements that define what the system will do, performance requirements that specify measurable criteria, design constraints that outline limitations imposed by external factors such as regulations or environmental conditions, and/or others.

Test and evaluation requirements can ensure that the system associated with the MBSE model 208 meets its intended purpose by defining the necessary verification and validation processes. Test and evaluation requirements can outline how the system's performance, reliability, and compliance with standards will be assessed. The test and evaluation requirements can include test conditions, pass/fail criteria, the methods by which components and subsystems will be examined, whether through simulations, physical testing, or operational trials, and/or other aspects.

Sustainment requirements can address the long-term maintenance, support, and lifecycle considerations of the system associated with the MBSE model 208, which can ensure that the system can be effectively operated and supported over time. Sustainment requirements can include reliability, maintainability, logistics, serviceability, and/or other aspects. Sustainment requirements can define aspects such as spare parts availability, failure recovery mechanisms, software update processes, etc., which can help organizations manage costs and system longevity.

Collaboration requirements can indicate how different stakeholders, teams, and systems are intended to interact throughout the development lifecycle of the system associated with the MBSE model 208. The collaboration requirements can define communication protocols, data sharing methods, and integration points between subsystems and external entities.

Additional or alternative divisions or subcategories of requirements may be used in the requirements representation 236. For instance, the requirements representation 236 may depict divisions of requirements such as performance (e.g., defining quantitative measures such as speed, efficiency, or capacity), functional (e.g., specifying what the system should do to meet its intended purpose), interface (e.g., addressing how the system interacts with other systems, components, or users), regulatory (e.g., ensuring compliance with industry standards, laws, and safety guidelines), security (e.g., outlining protections against cyber threats, unauthorized access, and data integrity risks), and/or others.

The requirements representation 236 may visually depict the requirements associated with the MBSE model 208 using a structured approach. In one example, the requirements representation 236 depicts the various requirements using a leveled structure, where requirements are broken down into parent and child relationships to define high-level system needs and progressively more detailed specifications. By way of illustrative example, a leveled structure implemented by the requirements representation 236 can begin with top-level system requirements, which define the broad capabilities or constraints of the system. These may be labeled with a numbering scheme such as 1.0, 2.0, and so on. Beneath each high-level requirement, lower-level requirements can refine and expand upon the broader statement of the top-level system requirements, providing more detail about specific functions, constraints, verification criteria, etc. For example, a top-level development requirement (e.g., 1.0) might state that the system must operate within a defined environmental range. A second-level requirement (e.g., 1.1) could specify that the system must function in temperatures between −40° C. and 85° C., while third-level requirements (e.g., 1.1.1 and 1.1.2) might further detail the system's operational characteristics at extreme temperatures. As another example, a top-level test and evaluation requirement might define that the system should be validated against all intended operational scenarios, while a second-level requirement could then specify a set of conditions under which testing must occur, such as vibration, thermal cycling, or shock resistance. Lower levels might establish test methods, pass/fail criteria, and data recording protocols. As still another example, a top-level sustainment requirement might state that the system must be serviceable in the field. A second-level requirement could specify that modular components should be replaceable without specialized tools, and lower-level requirements might define allowable downtime, logistics support, or software update intervals. As another example, a top-level collaboration requirement might establish the need for seamless data exchange between engineering teams. Lower-level requirements could then define specific interoperability standards, communication protocols, or model integration techniques to be used across different disciplines.

Requirements can be visually organized in the requirements representation 236 in several ways. As noted above, hierarchical trees may be used to present parent-child relationships, breaking down high-level requirements into progressively detailed sub-requirements. In some instances, traceability matrices may be used link requirements to design elements, test cases, and verification activities to ensure full coverage. In some implementations, flow diagrams may be used to map dependencies and interactions between different requirement categories or system components. In some examples, model-based representations, such as SysML diagrams, may be used to integrate requirements into system architecture, showing relationships with components, behaviors, and constraints. Tables or structured lists may additionally or alternatively be used to provide a tabular format with attributes such as priority, status, and verification method for easy tracking and management.

In some implementations, the one or more deployed systems 228 that correspond to the physical system 202 and the MBSE model 208 are deployed in a real-world operational environment, such as a commercial or governmental implementation. By way of illustrative example, the deployed system(s) 228 may comprise one or more automotive systems (e.g., a vehicle fleet), each having a unique identity (e.g., indicated by a serial number or other identifier code). Sensor data 230 and/or log data 232 (or event data) can be captured for each of the deployed system(s) 228. In an example of deployed system(s) 228 comprising automotive systems, the sensor data 230 can include or indicate battery health and voltage, brake pad wear, tire pressure, filter status, suspension health, electrical system anomalies, steering system status, fluid quality and/or level, exhaust composition, pressure values, component positioning, and/or others. In an example of deployed system(s) 228 comprising automotive systems, the log data 232 can include or indicate diagnostic trouble codes (DTCs), start and stop times, fuel or battery consumption logs, maintenance alerts and events, charge/discharge cycles and battery health, braking events, acceleration patterns, speed data, system performance, temperature logs/events, steering and suspension events, and/or others. Each of the deployed system(s) 228 can be associated with or represented by a respective interactive digital twin 212 such that the sensor data 230 and/or log data 232 obtained for a deployed system 228 can be used to update its respective interactive digital twin 212. For example, log entries of needed maintenance or maintenance activities performed may be entered via the interactive digital twin 212 in association with one or more deployed systems 228, enabling the interactive digital twin 212 to be used to track and/or manage maintenance activities for deployed system(s) 228 that correspond to the physical system 202. As another example, sensor data 230 and/or log data 232 for a deployed system 228 can be used to update component details 226 for its respective interactive digital twin 212, such as states or state variables for the deployed system 228 represented in the component details 226 of the interactive digital twin 212 for the deployed system 228. In some implementations, the states or state variables (or other component details 226) can be processed by one or more predictive models 234 (or other models/algorithms) to predict future states of the deployed system(s) 228, recommended actions for the deployed system(s) 228 (e.g., maintenance actions), alerts (e.g., based on predicted failures of one or more components), and/or other outputs. Such outputs can be presented on a user interface as part of the component details 226 for an interactive digital twin 212.

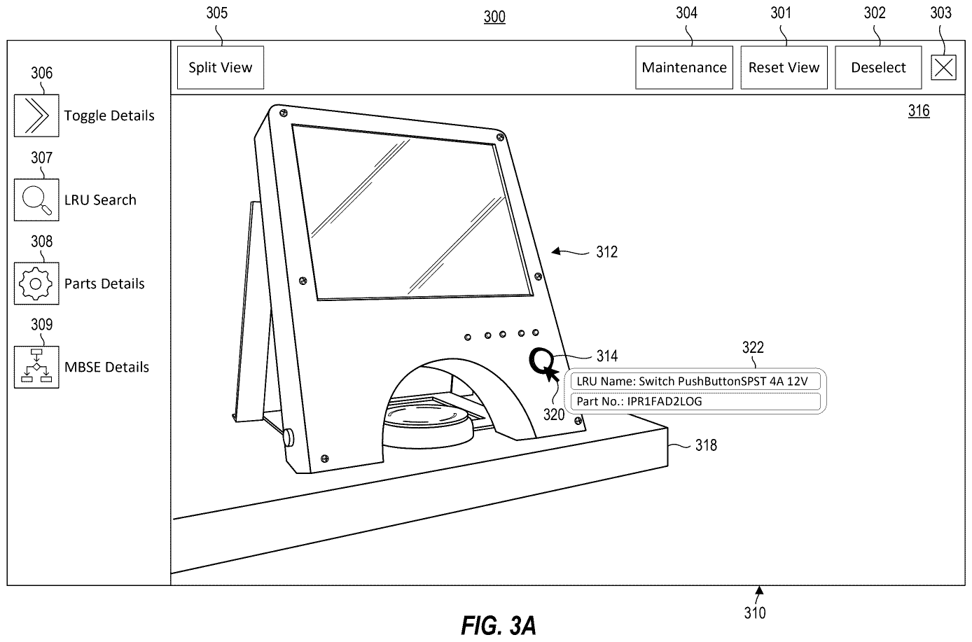

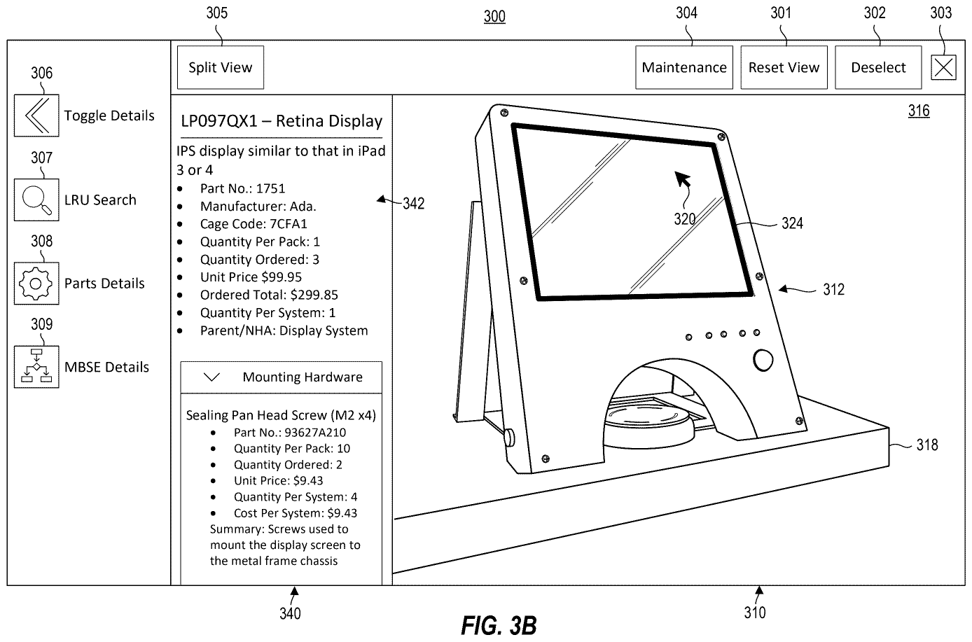

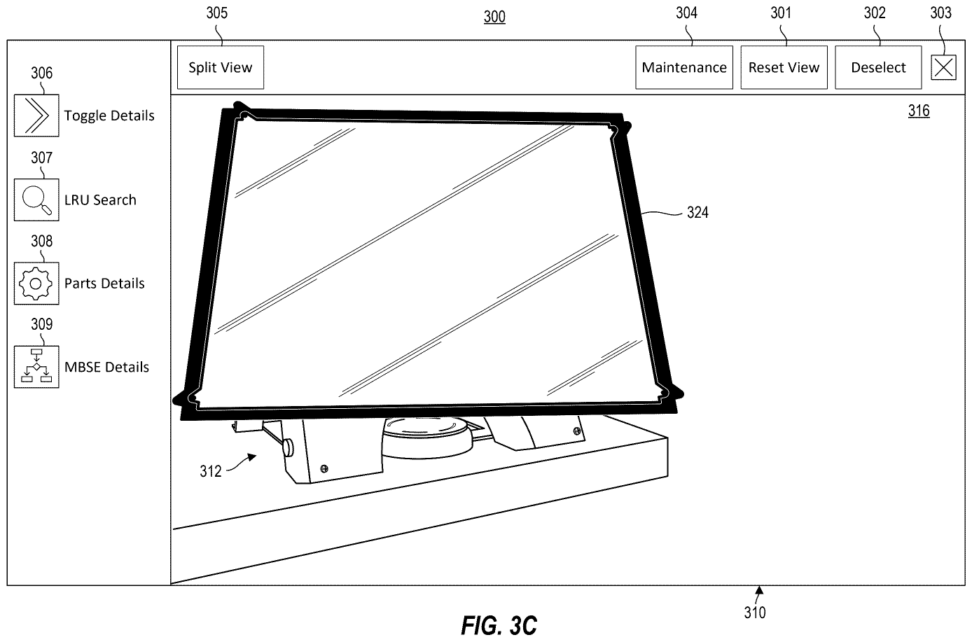

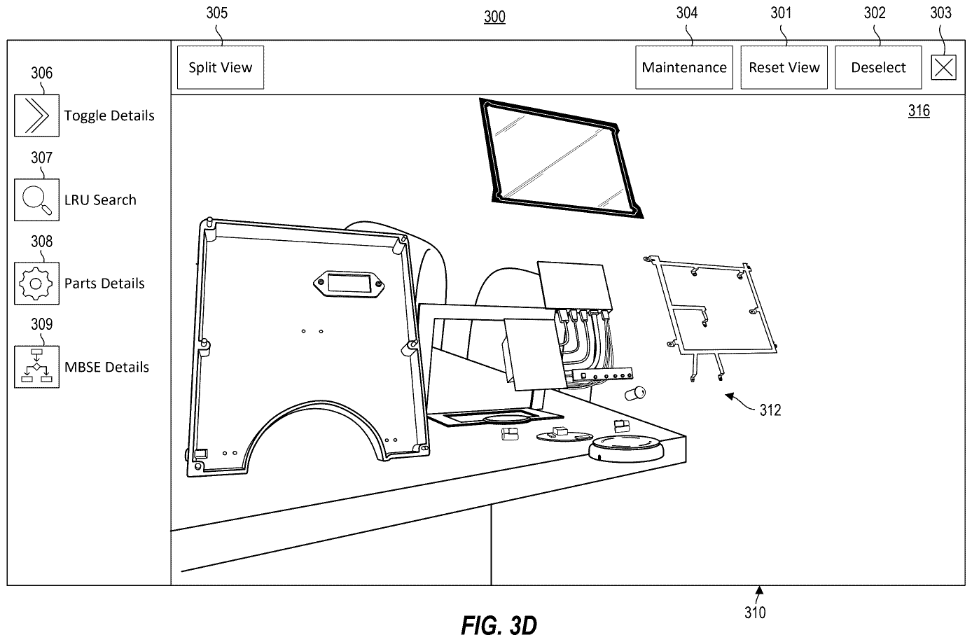

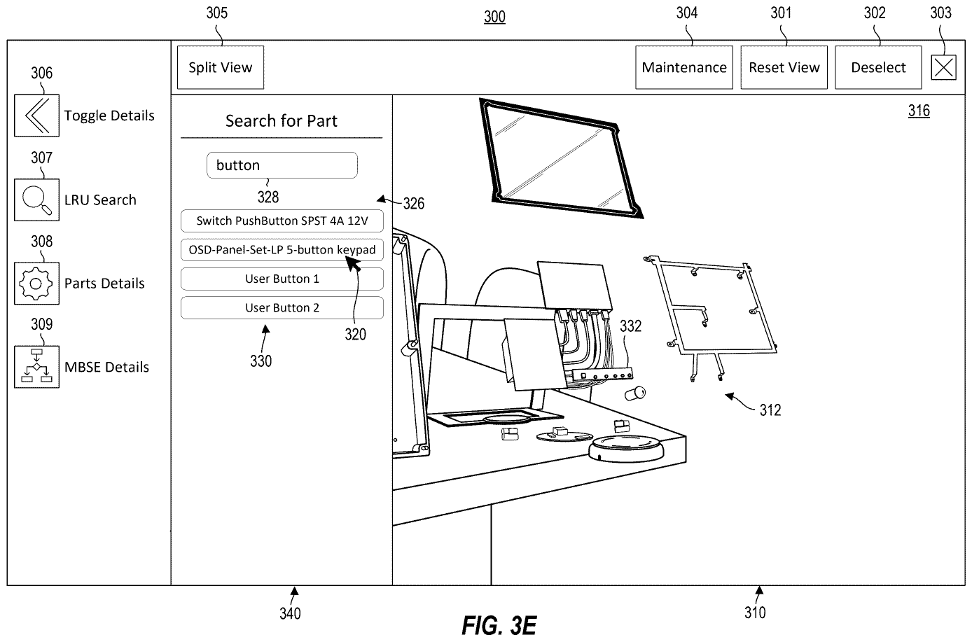

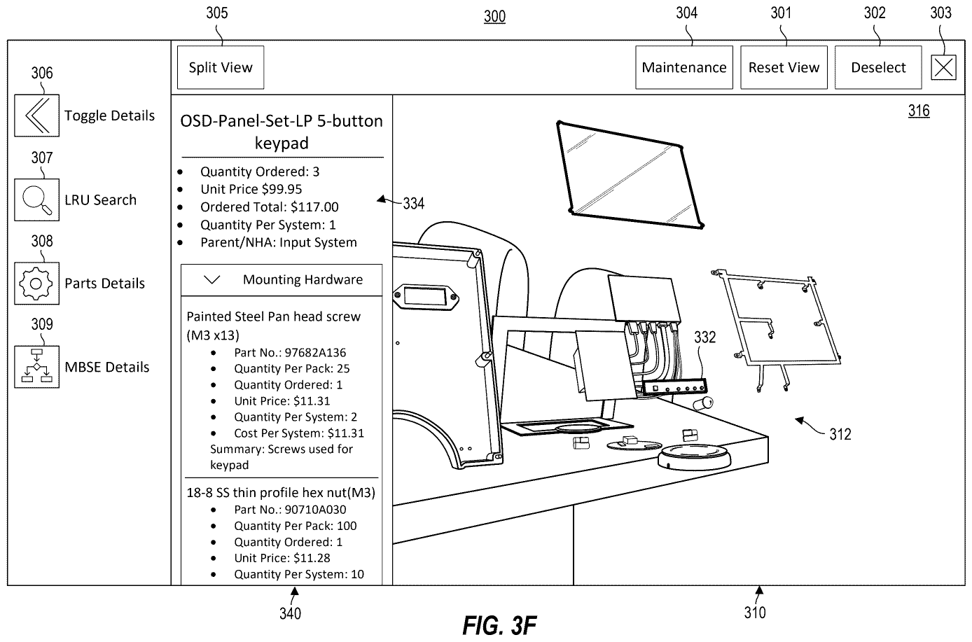

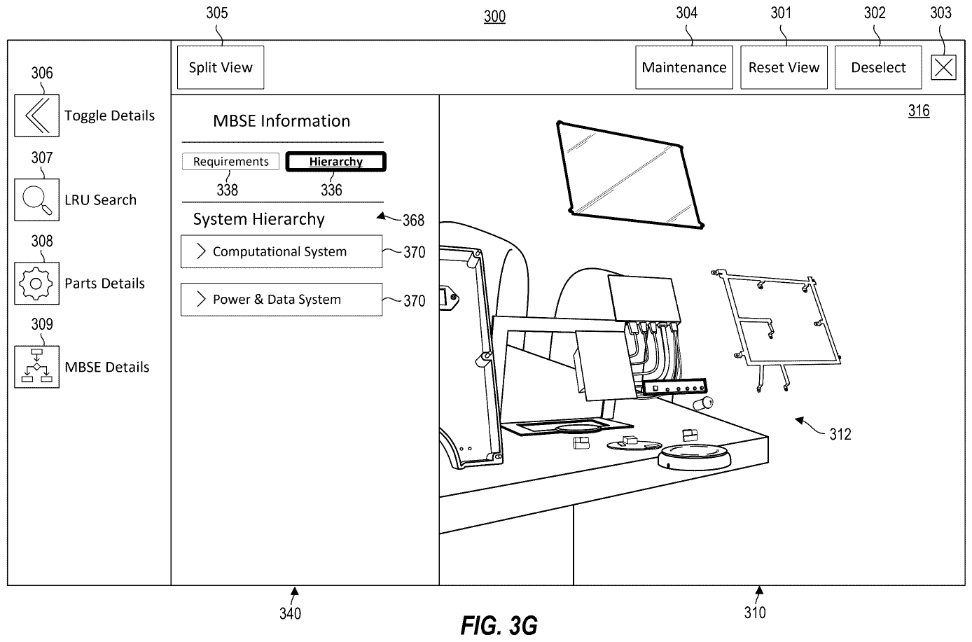

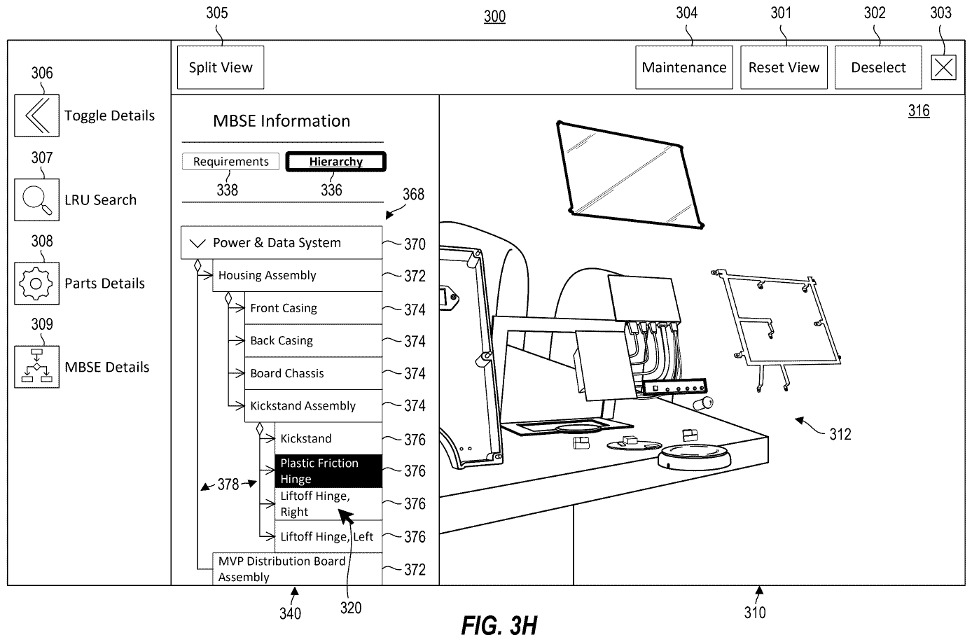

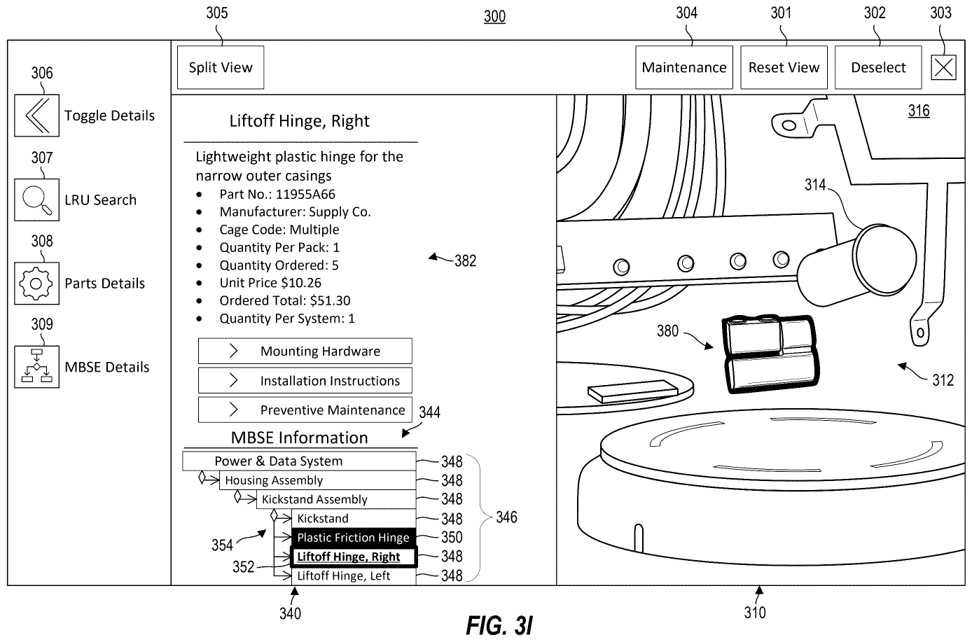

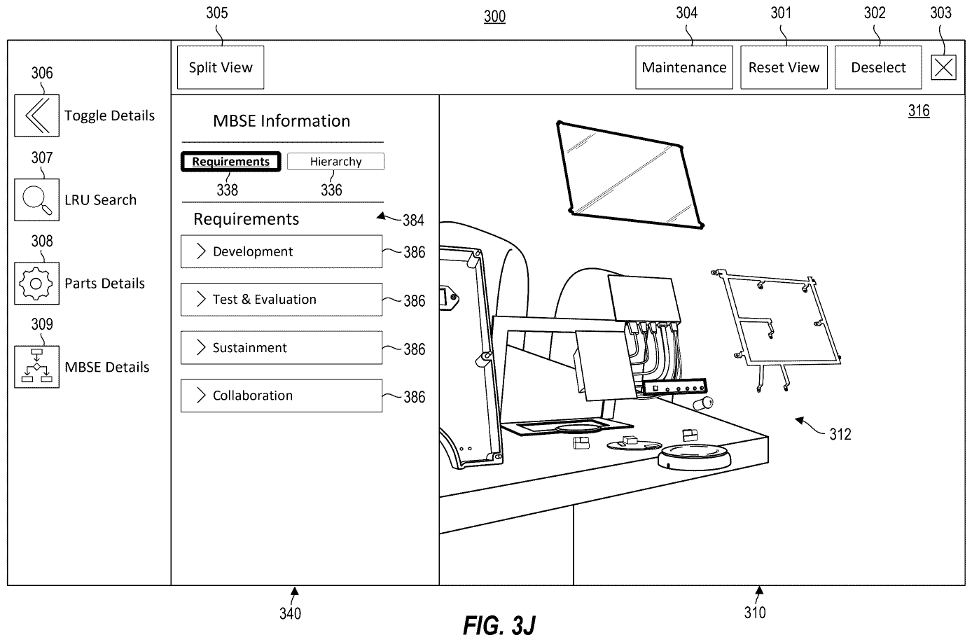

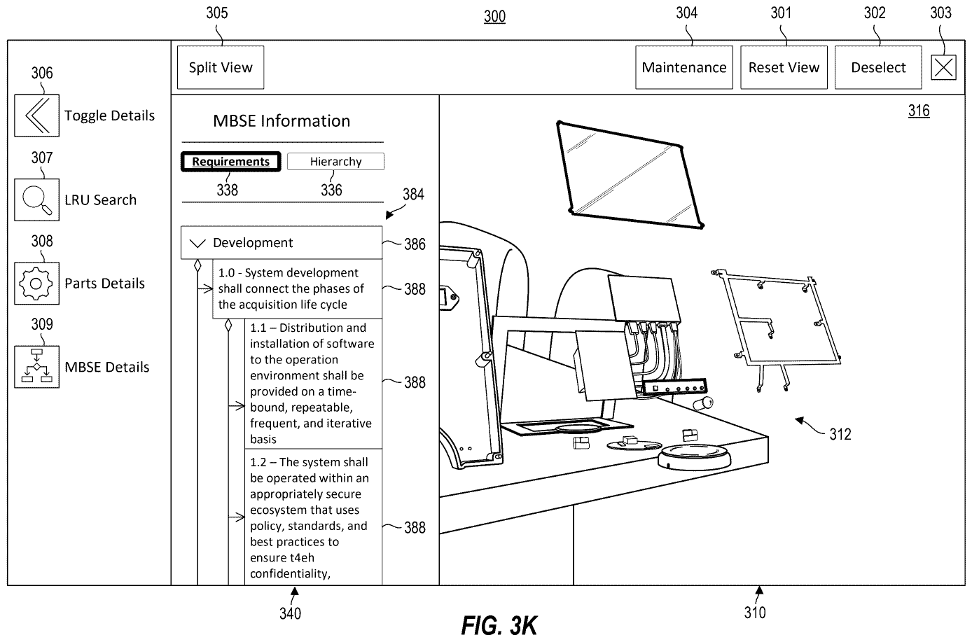

FIGS. 3A through 3K illustrate example user interface displays that may present various elements associated with an interactive digital twin with integrated data (e.g., corresponding to interactive digital twin 212). FIG. 3A illustrates an example user interface 300 including a viewing region 310. Elements/aspects of the user interface 300 can be implemented and displayed using a wide variety of user devices (e.g., corresponding to system 100), such as desktop computers, laptop computers, mobile electronic devices, wearable devices (e.g., head-mounted displays), and/or others.

The user interface 300 can present various aspects of an interactive digital twin 212, as described hereinabove with reference to FIG. 2. In the example of FIG. 3A, the viewing region 310 presents a 3D representation 312 of a physical system (which may correspond to the visual representation 214 of the interactive digital twin 212 that represents the physical system 202 described hereinabove). The viewing region 310 may present the 3D representation 312 in navigable form. For instance, presenting the 3D representation 312 at the user interface 300 can involve enabling a user of a system running or executing the user interface 300 to provide control input to modify the positioning of a virtual camera relative to the 3D content, enabling modification of the view frustrum represented in the viewing region 310 (regardless of whether the 3D representation 312 is actually shown on-screen at any given moment).

In the example shown in FIG. 3A, the 3D representation 312 is depicted within an environment 316 that includes additional objects (e.g., a table 318) that are not part of the physical system 202 (e.g., defined by the MBSE model 208) represented by the 3D representation 312. Such features can provide users with size, usage, environmental, and/or other context when interacting with the 3D representation 312 shown in the viewing region 310.

The user interface 300 of FIG. 3A also includes various selectable elements, such as a reset view element 301 (e.g., for resetting a view perspective for viewing the 3D representation 312 within the environment 316 to an initial or default state), a deselect element 302 (e.g., for deselecting previously selected 3D components of the 3D representation 312), a close element 303 (e.g., for exiting the user interface 300), a maintenance element 304 (e.g., for causing presentation of a maintenance interface), a split view element 305 (e.g., for facilitating presentation of a split or exploded view of the 3D representation 312 of the physical system 202), a toggle details element 306 (e.g., for hiding or showing a details region 340, shown hereafter), a search element 307 (e.g., for enabling searching among the components of the physical system 202 represented by the 3D representation 312), a component details element 308 (e.g., for hiding or showing component details within the details region 340), and an MBSE details element 309 (e.g., for hiding or showing MBSE details within the details region 340). A user interface 300 may include additional or alternative features and/or selectable components.

In some implementations, the user interface 300 is configured to showcase movement capabilities and/or animations of one or more 3D components of the 3D representation within the viewing region 310.

The 3D representation 312 shown in FIG. 3A can include various 3D components representative of individual physical components of the physical system represented by the 3D representation 312 (e.g., corresponding to the 3D components 216 of the visual representation 214 of the interactive digital twin 212 representative of the physical components 204 of the physical system 202, described above). FIG. 3A shows an example 3D component of the 3D representation 312 in the form of a button 314. In some implementations, the 3D components of the 3D representation 312 may be selectable within the viewing region 310 to permit users to explore system-level details (e.g., from the MBSE model 208 as represented in the interactive digital twin 212) related to the selected 3D component.

In some examples, the user interface 300 is configured to receive multiple types of user input directed to the 3D components of the 3D representation 312. For instance, the user interface 300 can be configured to receive a first type of user input (e.g., clicking, tapping, long pressing, voice, gesture, gaze) that causes selection of a 3D component to trigger surfacing/display of component and/or MBSE details associated with the selected 3D component. The user interface 300 can be further configured to receive a second type of user input (e.g., hovering a selection icon or using a different format of clicking, tapping, long pressing, voice, gesture, or gaze input) that causes presentation of a visual indication that a 3D component of the 3D representation 312 is selectable for exploration of more granular details (e.g., component details and/or MBSE information). For instance, FIG. 3A illustrates an instance in which hovering a selection cursor 320 over the button 314 causes modification of the presentation (i.e., bolded bordering/outlining) of the button 314 to indicate that the button 314 is selectable for exploration of further details/aspects. Other modalities of visual emphasis aside from bolded bordering/outlining may be used (e.g., highlighting or color-changing, enlarging, etc.).

In some instances, when the second type of user input is directed to a selectable 3D component, certain details associated with the selectable 3D component may be presented within the viewing region 310. For instance, FIG. 3A illustrates an instance in which basic details 322 (e.g., including “LRU Name”, where LRU corresponds to “line-replaceable unit”, and “Part No.”) of the button 314 are presented in the viewing region 310 when the selection cursor 320 is hovered over the button 314. Such functionality can enable users to readily ascertain basic details about visible components without navigating complex interfaces.

FIG. 3B illustrates an example in which a first type of user input (e.g., clicking, tapping, or another form) has been directed to a display 324 of the 3D representation 312 within the viewing region 310 user interface 300, where the display 324 corresponds to a physical component 204 of the physical system 202 represented by the 3D representation 312. In the example shown in FIG. 3B, selection of the display 324 triggers visual emphasis of the display 324 within the viewing region 310 (e.g., via a bolded boundary/outline). Such a presentation can readily communicate to users which 3D component of the 3D representation 312 that has been selected, which can mitigate user confusion. Other forms of emphasizing the selected 3D component than that shown in FIG. 3B may be implemented.

FIG. 3B also illustrates a details region 340 as being surfaced and/or populated with system-level details associated with the display 324 (e.g., in response to selection of the display 324 within the viewing region 310 as discussed above). For instance, the details region 340 of FIG. 3B includes component details 342, which may correspond to component details 226 for the associated display from the physical system 202 described hereinabove. In the example shown in FIG. 3B, the component details 342 indicate, for the display 324, the component title (i.e., “LP097QX1-Retina Display”), a component description (i.e., “IPS display similar to that in iPad 3 or 4”), a part number (i.e., “Part No.: 1751”), a manufacturer, a model number or cage code, order and/or pricing information (i.e., “Quantity Per Pack”, “Quantity Ordered”, “Unit Price”, “Ordered Total”), the parent or NHA (i.e., “Display System”), and system implementation information (e.g., “Quantity Per System”, “Mounting Hardware” and information thereunder). Additional or alternative system-level details corresponding to the component details 226 for the selected physical component may be displayed in the component details 342 of the details region 340 (e.g., dimensions, weight, material(s), system type, performance metrics/parameters, maintenance information, etc.).

The user interface 300 may provide additional functionality for facilitating inspection of individual 3D components of a 3D representation shown in the viewing region 310. For instance, FIG. 3C illustrates an example in which the details region 340 has been hidden (e.g., via user input directed to the toggle details element 306) and a user input for triggering inspection of the selected 3D component (i.e., the display 324) has been received. The user input for triggering inspection of the selected 3D component can take on various forms, such as a keystroke, selection of a selectable element shown on the user interface 300, a third type of user input directed to the selected 3D component, and/or others. After receiving the user input for triggering inspection of the selected 3D component, the user interface 300 can provide a modified representation of the selected 3D component. For instance, FIG. 3C illustrates an example in which the presentation of the display 324 within the viewing region 310 has been modified such that the display 324 is displaced from its NHA (e.g., the overall display system of the 3D representation 312). FIG. 3C specifically shows the display 324 as being translated outward from the 3D representation 312 so as to permit inspection of the display 324 in isolation from the other componentry of the 3D representation 312 of the physical system 202. For instance, when providing the isolated representation of the display 324, the user interface 300 can be configured to respond to additional user inputs to facilitate rotation and/or zooming of the depiction of the display 324. As another example, the user interface 300 can be configured to provide exploded or split depictions of components of a physical system 202 represented by the 3D representation 312. For instance, FIG. 3D illustrates a split representation of the 3D representation 312 (e.g., after selection of the split view element 305) where one or more individual 3D components of the 3D representation 312 are displaced from one another. Such functionality can enable stakeholders to visualize and/or understand aspects and/or interconnections of components of an overall system intuitively.

In some implementations, the user interface 300 provides a search function to assist users with identifying and/or locating components of the physical system 202 represented by the 3D representation 312 for further analysis. For instance, FIG. 3E illustrates the details region 340 populated with a search tool 326 (e.g., after selection of the search element 307). The search tool 326 includes a query field 328 in which users can enter search terms (e.g., “button”), which can yield results 330 (e.g., selectable elements corresponding to 3D components of the 3D representation 312) that include terms that correspond or are related to the search terms in the query field 328. FIG. 3E illustrates the selection cursor 320 selecting one of the results 330 (e.g., corresponding to a button keypad 332), which can trigger selection of the corresponding 3D component within the viewing region 310. FIG. 3F illustrates the button keypad 332 of the 3D representation 312 in a selected state (e.g., indicated by a bolded boundary/outline), responsive to selection of the corresponding selectable element from the results 330 shown in FIG. 3E. FIG. 3F also illustrates the details region 340 populated/surfaced with component details 334 associated with the button keypad 332. Such functionality can enable users to readily locate and/or navigate to representations and/or information related to components of interest.

As noted above, the user interface 300 can be configured to provide MBSE information (e.g., corresponding to the MBSE hierarchy representation(s) 218 and/or the requirements representation 236 of the interactive digital twin 212). For instance, FIG. 3G illustrates the details region 340 of the user interface 300 surfaced/populated with MBSE information (e.g., after selection of the MBSE details element 309). In the example shown in FIG. 3G, the MBSE information includes an MBSE hierarchy representation 368 (e.g., corresponding to the MBSE hierarchy representation(s) 218) which includes various labels (e.g., corresponding to the labels 220). In some instances, the user interface 300 enables toggling between the MBSE hierarchy representation 368 (e.g., via selectable element 336) and MBSE requirements information (e.g., via selectable element 338).

FIG. 3G illustrates top-level labels 370 of the MBSE hierarchy representation 368, which can correspond to top-level assemblies/subsystems defined by the MBSE artifacts 210 used to construct the interactive digital twin 212. The top-level labels 370 shown in FIG. 3G are presented as collapsible list elements that can be selected to trigger display or hiding of lower-level labels (associated with lower-level assemblies/subsystems/components defined by the MBSE artifacts 210 used to construct the interactive digital twin 212). FIG. 3H illustrates the MBSE hierarchy representation 368 with the top-level label 370 associated with the “Power & Data System” of the physical system 202 in a selected state, triggering display of the corresponding lower-level labels. FIG. 3H illustrates second-level labels 372, third-level labels 374, and fourth-level labels 376, illustrating the hierarchical structure of components of the power & data subsystem of the physical system 202. The second-level labels 372, third-level labels 374, and/or fourth-level labels 376 may also be interactable to facilitate display and/or hiding of respective lower-level labels. For instance, the third-level label 374 associated with the “Kickstand Assembly” can be selectable to trigger selective showing or hiding of its lower-level labels (e.g., associated with the “Kickstand”, “Plastic Friction Hinge”, “Liftoff Hinge, Right”, and “Liftoff Hinge, Left”). One will appreciate, in view of the present disclosure, that a MBSE hierarchy representation 368 can include any quantity of labels with any quantity of hierarchical levels.

In the example shown in FIG. 3H, the MBSE hierarchy representation 368 is illustrated with a relational structure to indicate the hierarchical relationships among the components associated with the presented labels (e.g., top-level labels 370, second-level labels 372, third-level labels 374, fourth-level labels 376, etc.). For instance, the labels shown in the MBSE hierarchy representation 368 of FIG. 3H include different offsets, spacing, or alignment corresponding to their hierarchical level. For instance, the leftmost boundaries of the second-level labels 372 are offset to the right relative to the leftmost boundaries of the top-level labels 370 within the MBSE hierarchy representation 368, and lower-level labels have increasing offsets from the top-level labels 370. The MBSE hierarchy representation 368 further includes visual links 378 showing hierarchical relationships between each higher-level label/component and its corresponding lower-level labels/components. One will appreciate, in view of the present disclosure, that other schema for representing hierarchical level for labels of a MBSE hierarchy representation 368 are within the scope of the present disclosure.

In some implementations, selection of a label from the MBSE hierarchy representation 368 can trigger navigation to and/or presentation of a corresponding 3D component within the viewing region 310 (e.g., where the selected label and the corresponding 3D component are associated with the same physical component of the physical system 202 represented by the interactive digital twin 212). For instance, FIG. 3H illustrates the selection cursor 320 positioned to select a fourth-level label 376 associated with the physical component “Liftoff Hinge, Right”. FIG. 3I illustrates the viewing region 310 having been navigated to showcase the right liftoff hinge 380 of the 3D representation 312, with the right liftoff hinge 380 being illustrated in emphasized form (e.g., via a bolded boundary/outline).

In some implementations, after selection of a label from the MBSE hierarchy representation 368, the presentation of the MBSE hierarchy representation 368 may persist within the details region 340, such that the showcasing of the corresponding 3D component within the viewing region 310 occurs simultaneously with the presentation of the MBSE hierarchy representation 368 within the details region 340. In some instances, selection of a label from the MBSE hierarchy representation 368 triggers presentation of additional and/or alternative details related to the corresponding physical component within the details region 340, such that these additional and/or alternative details are presented within the details region 340 simultaneous with the showcasing of the corresponding 3D component within the viewing region 310. In the example shown in FIG. 3I, after selection of the fourth-level labels 376 associated with the right liftoff hinge 380, the details region 340 is populated/surfaced with component details 382 associated with the right liftoff hinge 380 and/or another MBSE hierarchy representation 344.

The component details 382 can include information similar to the component details 342 and/or 334 discussed hereinabove with reference to FIGS. 3B and 3F. The component details 382 shown in FIG. 3I further include “Installation Instructions” and “Preventive Maintenance” information, which can provide users/stakeholders with further details related to installing and/or using/maintaining the selected component.

In some instances, the MBSE hierarchy representation 344 may be regarded as a sparse MBSE hierarchy representation relative to the MBSE hierarchy representation 368 discussed above. Similar to the MBSE hierarchy representation 368, the MBSE hierarchy representation 344 may include labels 346 that correspond to the labels 220 of the interactive digital twin 212 described hereinabove, including a particular label 352 associated with the right liftoff hinge 380 (e.g., corresponding to the fourth-level label 376 associated with the right liftoff hinge 380 that was selected from the MBSE hierarchy representation 368). In some implementations, the labels 346 included in the MBSE hierarchy representation 344 are selected based on relevance to the selected component (e.g., the right liftoff hinge 380, regardless of whether the component is selected via a label of a MBSE hierarchy representation or via a 3D component in a 3D representation). For instance, in the case of the right liftoff hinge 380 shown in FIG. 3I, the labels 346 of the MBSE hierarchy representation 344 may include labels representative of at least the parent assembly or NHA of the right liftoff hinge 380 (e.g., the “Kickstand Assembly”), as well as one or more labels for one or more additional child assemblies/components of the parent assembly or NHA (which relationships may be defined by the MBSE model 208 and represented in the interactive digital twin 212). Additional labels related to higher-level and/or lower-level assemblies may be presented within the MBSE hierarchy representation 344 in response to selection of a component, and the particular labels shown can be tailored/tuned based on user preferences, machine learning, etc. The MBSE hierarchy representation 344 may thus selectively depict only a subset of component labels for the physical system 202 that are relevant to the selected component. Such functionality can provide focused information from the overall MBSE model 208 without overwhelming users.

The labels 346 of the MBSE hierarchy representation 344 can include different sets of labels having different visual characteristics within the MBSE hierarchy representation 344. In the example shown in FIG. 3I, the labels 346 include a first set of labels 348, which may correspond to the tangible component labels 222 (discussed above) that describe physical components 204 of the physical system 202 that are represented by a 3D component in the 3D representation 312. The labels 346 of the MBSE hierarchy representation 344 of FIG. 3I also include a second set of labels 350, which may correspond to (i) the tangible component labels 222 (discussed above) that describe physical components 204 of the physical system 202 that are not represented by a 3D component in the 3D representation 312 and/or (ii) the intangible component labels 224 discussed hereinabove. The 3D representation 312 may lack one or more 3D components representing certain physical components 204 of the physical system 202 for various reasons, such as security constraints, confidentiality constraints, incompleteness of the MBSE model 208 providing the basis for the interactive digital twin 212 (e.g., where the interactive digital twin 212 is constructed early in a project lifecycle), etc. By including labels for such absent components, a MBSE hierarchy representation 344 may provide a more comprehensive/detailed view of the structure of system components in the represented system, even where certain 3D components are omitted from the 3D representation. In the example shown in FIG. 3I, the second set of labels 350 includes a “Plastic Friction Hinge” label, which corresponds to a physical components 204 of the physical system 202 that is not depicted by a 3D component of the 3D representation 312. The intangible component labels 224 that can be represented in the second set of labels 350 of the MBSE hierarchy representation 344 can include software, firmware, data/information, signals/messages, protocols, standards, user interfaces/experiences, services/processes, logical components, system behaviors/functions, and/or other components that rely on, are stored by, and/or interact with physical components of the physical system 202.

The first set of labels 348 and the second set of labels 350 can be depicted with different visual characteristics. As shown in FIG. 3I, the first set of labels 348 have white backdrops with black text, whereas the second set of labels 350 have black backdrops with white text. Other visual distinctions may be used to visually distinguish between the first set of labels 348 (associated with tangible components of the physical system 202 represented by the MBSE model 208, the interactive digital twin 212, and the 3D representation 312) and the second set of labels 350 (associated with the intangible components of the physical system 202 represented by the MBSE model 208 and the interactive digital twin 212) within a user interface 300.

The MBSE hierarchy representation 344 also provides an emphasized representation of a particular label 352 of the first set of labels 348 that represents the right liftoff hinge 380 (i.e., the selected component). In the example shown in FIG. 3I, the particular label 352 is emphasized by using bolded and underlined text, as well as an enlarged border for the particular label 352 (relative to the other labels 346). Other emphasis methods for a particular label corresponding to a selected component may be utilized in accordance with the principles disclosed herein.

FIG. 3I also illustrates a relational structure indicating relationships of the labels 346 of the MBSE hierarchy representation 344 (e.g., similar to the relational structure described above in association with the MBSE hierarchy representation 368). The relational structure can illustrate parent-child relationships, sibling relationships, and/or other relationships among the components of the physical system 202 that are associated with the labels 346 (which relationships can be defined in the MBSE model 208 and represented in the interactive digital twin 212 for the physical system 202). In the example shown in FIG. 3I, the relational structure is implemented as visual links 354 (e.g., lines/arrows) that connect various labels 346 to one another. Other relational structures may be utilized (e.g., color coding, shading/gradient coding, proximity or spatial layout, enclosures, matching symbols/markers, layering, size scaling, etc.).

Additionally, or alternatively, the labels 346 of the MBSE hierarchy representation 344 may be presented in the user interface 300 according to a hierarchical structure that indicates the respective hierarchical level of the components of the physical system 202 that are associated with each label 346. The hierarchy levels may be defined by the MBSE model 208 for the physical system 202. Example hierarchy levels for components represented by the labels 346 can include a top level (e.g., the highest or overall system level) and lower levels corresponding to more granular structures and substructures of the system (e.g., the subsystem level, the assembly/module level, the part/element level, etc.). In the example of FIG. 3I, the hierarchy levels of the system components associated with the labels 346 are indicated by the size and/or positioning (e.g., offsets) of the labels 346 within the MBSE hierarchy representation 344. Other visual depictions of hierarchical structure for the labels 346 of the MBSE hierarchy representation 344 may be utilized (e.g., color coding, shading/gradient coding, proximity or spatial layout, enclosures, matching symbols/markers, layering, size scaling, etc.). In some implementations, a combination of a relational structure and a hierarchical structure is used for the labels 346, as shown in FIG. 3I.

By showing labels representative of physical/tangible components (whether corresponding 3D components are present in the 3D representation 312 or not) and intangible components of a physical system in conjunction with a 3D representation of the physical system, as well as providing an indication of relationships among the components, users may be provided with a comprehensive view of system components and their relevance to one another that is intuitive and understandable (e.g., without relying on user expertise in interpreting MBSE system models in system modeling languages).

In some implementations, the labels 346 of the MBSE hierarchy representation 344 are provided as selectable components, enabling users to use the MBSE hierarchy representation 344 to select components of the physical system 202 for analysis within the user interface 300. For instance, a user may select the label 346 of the MBSE hierarchy representation 344 corresponding to the “Liftoff Hinge, Left” component or the “Kickstand” component to trigger visualization/emphasis of said component(s) within the viewing region 310 and to trigger surfacing/presentation of different component details and/or an at least partially different MBSE hierarchy representation.

Although the foregoing example(s) have focused, in at least some respects, on selection of a label of an MBSE hierarchy representation to trigger visualization/emphasis of the corresponding 3D component of the 3D representation 312 (and/or presentation of component details and/or a sparse/focused MBSE hierarchy representation), such depictions can be triggered by selection of the 3D components from the 3D representation 312 shown in the viewing region 310, in some instances. For example, selection of the button 314 shown in the viewing region 310 of FIG. 3I can cause (i) the button 314 to become visually emphasized within the viewing region 310 (e.g., by shifting the view frustrum and/or by adding emphasis elements to the depiction of the button 314), (ii) the details region 340 to become populated with component details related to the button 314, and/or (iii) the details region 340 to become populated with a MBSE hierarchy representation related to the button 314 (e.g., a sparse MBSE hierarchy representation showing one or more different labels than the MBSE hierarchy representation 344 for the right liftoff hinge 380).

As indicated above, the details region 340 can be configured to present MBSE requirements information corresponding to requirements representation 236 of the interactive digital twin 212 (e.g., via selection of selectable element 338). Figure illustrates the user interface 300 after selection of the selectable element 338, showing the details region 340 surfaced/populated with a requirements representation 384 including various labels 386 indicating requirements associated with the physical system 202 (e.g., as represented in the MBSE artifacts 210 of the MBSE model 208 and the interactive digital twin 212). Similar to the MBSE hierarchy representation 368, the labels 386 of the requirements representation 384 may be provided in a collapsible list format (or other format) with a hierarchical structure illustrating nesting, dependence, and/or other relationships among the represented requirements. FIG. 3J illustrates top-level labels 386, and FIG. 3K illustrates lower-level labels 388 related to the top-level labels 386.

In some implementations, aspects of the details region 340 and/or the viewing region 310 can be modified based on one or more outputs of one or more simulations/models (e.g., predictive model(s) 234) associated with an interactive digital twin 212, described hereinabove. For instance, the viewing region 310 may be modified to depict predicted behavior of one or more components of the underlying physical system (e.g., based on predicted future states/failures/changes output by the predictive model(s) 234). The viewing region 310 can depict visualizations of output of one or more quantitative or qualitative aspects of processes/operations performed (e.g., manufacturing/production operations) or products generated/created by the physical system 202 based on the configuration of the MBSE model 208 defined by the MBSE artifacts 210. The output of the model(s) and/or the simulations may be updated or re-generated in real-time or near-real-time based on user modifications to the MBSE hierarchy representation(s) 218 and/or the requirements representation 236 shown in the details region 340 and described hereinabove (e.g., MBSE hierarchy representation 344, 368, requirements representation 384). Such functionality can enable users to explore downstream effects of modifications to the structure, components, parameters, operations, or interoperations of the physical system 202. As another example, one or more recommended actions or alerts output by the predictive model(s) 234 may be presented in the viewing region 310 and/or the details region 340 of the user interface 300 (e.g., where the 3D representation 312 represents a deployed system 228).

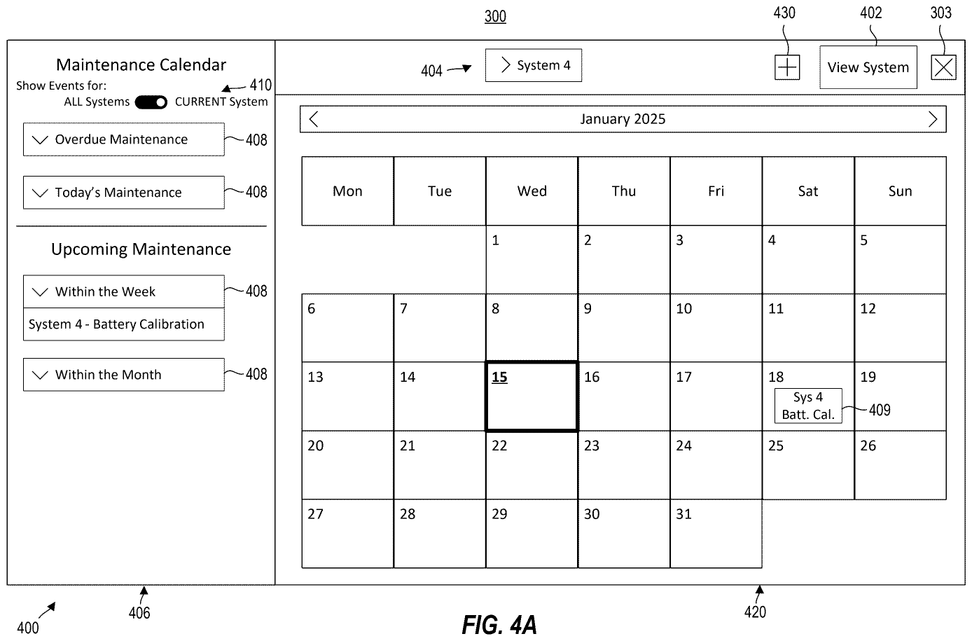

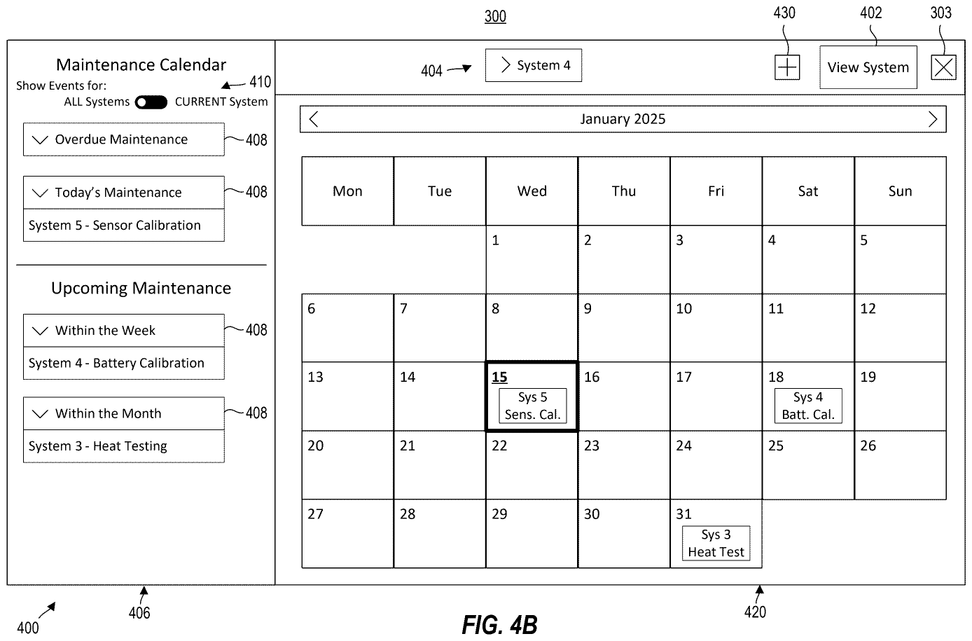

As noted above, the physical system 202 represented in the user interface 300 can correspond to one or more deployed systems 228. In such cases, the maintenance element 304 of the user interface 300 can be used to trigger presentation of a maintenance interface, which can enable users monitor and manage maintenance activities related to the deployed system(s) 228. FIG. 4A illustrates the user interface 300 showing a maintenance interface 400 (e.g., after selection of the maintenance element 304 described above). In the example shown in FIG. 4A, the maintenance interface 400 includes a digital twin element 402 that can enable the user to return to the user interface 300 including the viewing region 310 and the details region 340 for providing visualizations and/or information related to components of a physical system 202 (e.g., the deployed system 228).

The example maintenance interface 400 shown in FIG. 4A includes a system label 404, indicating the particular deployed system 228 for which maintenance information is presented in the maintenance interface 400. The system label 404 can comprise a selectable element that enables users to select different deployed systems 228 for maintenance management (e.g., where a fleet of system is deployed for which maintenance tasks are managed via the maintenance interface 400, where the deployed systems can comprise different instances of the same type of system or different types of systems). The maintenance interface 400 shown in FIG. 4A includes a maintenance tasks pane 406 and a maintenance calendar pane 420. The maintenance tasks pane can include various labels 408 showing maintenance tasks associated with various time horizons (e.g., “Overdue Maintenance”, “Today's Maintenance”, “Within the Week”, “Within the Month”). In the example shown in FIG. 4A, the maintenance tasks pane 406 illustrates a task of “Battery Calibration” for “System 4” at the “Within the Week” label within the maintenance tasks pane 406. This task of battery calibration for system 4 is also depicted via a label 409 in the maintenance calendar pane 420 (e.g., the “Sys 4 Batt. Cal.” Label within the Jan. 18, 2025, box of the maintenance calendar pane 420), advantageously providing users with multiple representations of maintenance tasks.

The example maintenance interface 400 can include a control 410 for determining whether (i) only maintenance information for the deployed system selected via the system label 404 is shown in the maintenance interface 400 or (ii) maintenance information for all deployed systems (e.g., in a group of deployed systems) is shown in the maintenance interface 400. In the example shown in FIG. 4A, the control 410 is configured to cause only maintenance information for system 4 to be shown in the maintenance interface 400. FIG. 4B illustrates the control 410 in an alternate configuration, where maintenance information for all systems in the corresponding group of deployed systems is shown in the maintenance interface 400 (e.g., including system 5, system 4, and system 3). Users can thus advantageously manage maintenance tasks for multiple deployed systems from a single user interface (which also provides the capability of displaying visual representations of the system, as described hereinabove with reference to FIGS. 3A-3K).

Selection of a representation of a maintenance task (e.g., within the maintenance tasks pane 406 and/or within the maintenance calendar pane 420) can surface additional information related to the maintenance task. For instance, selection of a label corresponding to the system 4 battery calibration task in the maintenance tasks pane 406 and/or the maintenance calendar pane 420 can surface a maintenance event details page, which can display which system the maintenance task is for (e.g., “System 4”), the name of the component on which the maintenance is to be performed (e.g., “Battery”), the maintenance type (e.g., “Calibration”), the due date for the maintenance task (e.g., “Jan. 18, 2025), and/or other details/information related to performance of the maintenance task (e.g., instructions, equipment/supplies needed, amount of time needed, system/component availability, etc.).

FIGS. 4A and 4B illustrate the maintenance interface 400 as including an add task element 430, which can enable users to add new maintenance tasks to the maintenance interface 400, which can then become represented by labels in the maintenance tasks pane 406 and/or the maintenance calendar pane 420. For example, selection of the add task element 430 can surface a new event page, enabling users to enter and/or select (e.g., from one or more dropdown or other menus having selectable items/elements) which system(s) the new maintenance task is applicable to (e.g., system 3, system 4, system 5), the component on which the maintenance task is to be performed, the type of maintenance task to be performed, the date on which the maintenance task is to be performed, whether and/or how frequently the maintenance task is to be repeated, additional details/information related to performance of the maintenance task (e.g., instructions, equipment/supplies needed, amount of time needed, system/component availability, etc.).

Disclosed embodiments include at least those in the following numbered clauses:

Clause 1. A computing system, comprising: one or more processors; and one or more computer-readable recording media that store instructions that are executable by the one or more processors to configure the computing system to: present a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system; present a model-based systems engineering (MBSE) hierarchy representation, wherein the MBSE hierarchy representation comprises a plurality of labels, wherein the MBSE hierarchy representation comprises a relational structure indicating one or more relationships among labels of the plurality of labels, wherein each label of a set of labels of the plurality of labels corresponds to a respective 2D or 3D component of the plurality of 2D or 3D components of the visual representation of the physical system, and wherein the one or more relationships among the labels of the plurality of labels are defined by a plurality of MBSE artifacts of an MBSE model for the physical system; receive user input directed to a particular label of the set of labels of the plurality of labels of the MBSE hierarchy representation, wherein the particular label corresponds to a particular 2D or 3D component of the plurality of 2D or 3D components of the visual representation of the physical system, wherein MBSE hierarchy representation depicts a relationship between the particular label and a higher-level label of the plurality of labels; and in response to receiving the user input directed to the particular label, navigate to and visually emphasize the particular 2D or 3D component within the presentation of the visual representation of the physical system.

Clause 2. The computing system of clause 1, wherein the instructions are executable by the one or more processors to configure the computing system to: present a selectable element for facilitating presentation of a requirements representation; and after receiving additional user input directed to the selectable element, present the requirements representation, wherein the requirements representation depicts one or more system requirements represented in the plurality of MBSE artifacts, wherein the one or more system requirements are presented in addition to the visual representation of the physical system.

Clause 3. The computing system of clause 1 or clause 2, wherein the plurality of MBSE artifacts comprise one or more of: structural diagrams, state machine diagrams, sequence diagrams, activity diagrams, requirements information, or parametric models.

Clause 4. The computing system of any one of clause 1 through clause 3, wherein the instructions are executable by the one or more processors to configure the computing system to: after receiving the user input directed to the particular label, present one or more component details for the respective physical component that corresponds to the particular 2D or 3D component, wherein the one or more component details are presented in addition to the visual representation of the physical system.

Clause 5. The computing system of any one of clause 1 through clause 4, wherein each label of the plurality of labels is presented according to a respective hierarchy level within the MBSE hierarchy representation.

Clause 6. The computing system of any one of clause 1 through clause 5, wherein the relational structure of the MBSE hierarchy representation comprises one or more visual links connecting one or more labels of the plurality of labels.

Clause 7. The computing system of any one of clause 1 through clause 6, wherein the instructions are executable by the one or more processors to configure the computing system to: receive user input directed to an additional label of the plurality of labels of the MBSE hierarchy representation; and in response to receiving the user input directed to the additional label: refrain from presenting the particular 2D or 3D component as emphasized within the presentation of the visual representation of the physical system; and visually emphasize an additional 2D or 3D component of the plurality of 2D or 3D components within the presentation of the visual representation of the physical system, wherein the additional label corresponds to the additional 2D or 3D component.

Clause 8. The computing system of any one of clause 1 through clause 7, wherein each label of a second set of labels of the plurality of labels corresponds to a respective component of the physical system not depicted in the visual representation.

Clause 9. The computing system of clause 8, wherein the set of labels and the second set of labels of the plurality of labels comprise different visual characteristics within the MBSE hierarchy representation.

Clause 10. The computing system of any one of clause 1 through clause 9, wherein the instructions are executable by the one or more processors to configure the computing system to: after receiving the user input directed to the particular label, modify the presentation of the particular to emphasize the particular label within the MBSE hierarchy representation.

Clause 11. The computing system of any one of clause 1 through clause 10, wherein the physical system comprises a deployed system, and wherein the instructions are executable by the one or more processors to configure the computing system to: present a selectable element for facilitating presentation of a maintenance interface; and after receiving additional user input directed to the selectable element, present the maintenance interface, wherein the maintenance interface depicts one or more maintenance tasks for the deployed system.

Clause 12. The computing system of any one of clause 1 through clause 11, wherein the visual representation further comprises one or more simulations associated with the physical system.

Clause 13. A computing system, comprising: one or more processors; and one or more computer-readable recording media that store instructions that are executable by the one or more processors to configure the computing system to: present a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system; receive user input directed to a particular 2D or 3D component of the plurality of 2D or 3D components of the visual representation; and in response to receiving the user input directed to the particular 2D or 3D component, present a model-based systems engineering (MBSE) hierarchy representation in addition to the visual representation of the physical system, wherein the MBSE hierarchy representation comprises a plurality of labels, wherein each label of a set of labels of the plurality of labels corresponds to a respective 2D or 3D component of the plurality of 2D or 3D components of the visual representation, wherein the set of labels comprises a particular label corresponding to the particular 2D or 3D component, wherein the particular label is presented as emphasized within the MBSE hierarchy representation, wherein the MBSE hierarchy representation comprises a relational structure indicating one or more relationships among labels of the plurality of labels, wherein MBSE hierarchy representation depicts a relationship between the particular label and a higher-level label of the plurality of labels, and wherein the one or more relationships among the labels of the plurality of labels are defined by a plurality of MBSE artifacts of an MBSE model for the physical system.

Clause 14. The computing system of clause 13, wherein the instructions are executable by the one or more processors to configure the computing system to: after receiving the user input directed to the particular 2D or 3D component, present one or more component details for the respective physical component that corresponds to the particular 2D or 3D component, wherein the one or more component details are presented in addition to the visual representation of the physical system.

Clause 15. The computing system of clause 13 or clause 14, wherein the instructions are executable by the one or more processors to configure the computing system to: receive user input directed to an additional 2D or 3D component of the plurality of 2D or 3D components of the visual representation; and in response to receiving the user input directed to the additional 2D or 3D component: refrain from presenting the MBSE hierarchy representation; and present an additional MBSE hierarchy representation in addition to the visual representation of the physical system, wherein the additional MBSE hierarchy representation comprises an additional plurality of labels, wherein each label of an additional set of labels of the additional plurality of labels corresponds to a respective 2D or 3D component of the plurality of 2D or 3D components of the visual representation, wherein the additional set of labels comprises an additional label corresponding to the additional 2D or 3D component, wherein the additional label is presented as emphasized within the additional MBSE hierarchy representation.

Clause 16. The computing system of any one of clause 13 through clause 15, wherein the instructions are executable by the one or more processors to configure the computing system to: after receiving the user input directed to the particular 2D or 3D component, modify the presentation of the visual representation to emphasize the particular 2D or 3D component.

Clause 17. The computing system of any one of clause 13 through clause 16, wherein the user input directed to the particular 2D or 3D component comprises a first type of user input, and wherein the instructions are executable by the one or more processors to configure the computing system to: after receiving a second type of user input directed to one or more 2D or 3D components of the visual representation, present a visual indication within the visual representation that the one or more 2D or 3D components comprise selectable components.

Clause 18. The computing system of any one of clause 13 through clause 17, wherein the physical system comprises a deployed system, and wherein the instructions are executable by the one or more processors to configure the computing system to: present a selectable element for facilitating presentation of a maintenance interface; and after receiving additional user input directed to the selectable element, present the maintenance interface, wherein the maintenance interface depicts one or more maintenance tasks for the deployed system.

Clause 19. The computing system of any one of clause 13 through clause 18, wherein the instructions are executable by the one or more processors to configure the computing system to: receive additional user input directed to inspecting the particular 2D or 3D component; and after receiving the additional user input, modify presentation of the particular 2D or 3D component to displace the particular 2D or 3D component relative to a next-higher assembly of the visual representation of the physical system.

Clause 20. A methods, comprising: presenting a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system; presenting a model-based systems engineering (MBSE) hierarchy representation, wherein the MBSE hierarchy representation comprises a plurality of labels, wherein the MBSE hierarchy representation comprises a relational structure indicating one or more relationships among labels of the plurality of labels, wherein each label of a set of labels of the plurality of labels corresponds to a respective 2D or 3D component of the plurality of 2D or 3D components of the visual representation of the physical system, and wherein the one or more relationships among the labels of the plurality of labels are defined by a plurality of MBSE artifacts of an MBSE model for the physical system; receiving user input directed to a particular label of the set of labels of the plurality of labels of the MBSE hierarchy representation, wherein the particular label corresponds to a particular 2D or 3D component of the plurality of 2D or 3D components of the visual representation of the physical system, wherein MBSE hierarchy representation depicts a relationship between the particular label and a higher-level label of the plurality of labels; and in response to receiving the user input directed to the particular label, navigating to and visually emphasizing the particular 2D or 3D component within the presentation of the visual representation of the physical system.

### Additional Details Related to Implementing the Disclosed Embodiments

Disclosed embodiments may comprise or utilize a special-purpose or general-purpose computer including computer hardware, as discussed in greater detail below. Disclosed embodiments also include physical and other computer-readable recording media for carrying or storing computer-executable instructions and/or data structures. Such computer-readable recording media can be any available media that can be accessed by a general-purpose or special-purpose computer system. Computer-readable recording media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry program code in the form of computer-executable instructions or data structures, and which can be accessed by a general-purpose or special-purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is currently claimed is:

1. A computing system, comprising:
one or more processors; and
one or more computer-readable recording media that store instructions that are executable by the one or more processors to configure the computing system to:
present a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system;
present a model-based systems engineering (MBSE) hierarchy representation, wherein the MBSE hierarchy representation comprises a plurality of labels, wherein the MBSE hierarchy representation comprises a relational structure indicating one or more relationships among labels of the plurality of labels, wherein each label of a set of labels of the plurality of labels corresponds to a respective 2D or 3D component of the plurality of 2D or 3D components of the visual representation of the physical system, and wherein the one or more relationships among the labels of the plurality of labels are defined by a plurality of MBSE artifacts of an MBSE model for the physical system;
receive user input directed to a particular label of the set of labels of the plurality of labels of the MBSE hierarchy representation, wherein the particular label corresponds to a particular 2D or 3D component of the plurality of 2D or 3D components of the visual representation of the physical system, wherein MBSE hierarchy representation depicts a relationship between the particular label and a higher-level label of the plurality of labels; and
in response to receiving the user input directed to the particular label, navigate to and visually emphasize the particular 2D or 3D component within the presentation of the visual representation of the physical system.

2. The computing system of claim 1, wherein the instructions are executable by the one or more processors to configure the computing system to:
present a selectable element for facilitating presentation of a requirements representation; and
after receiving additional user input directed to the selectable element, present the requirements representation, wherein the requirements representation depicts one or more system requirements represented in the plurality of MBSE artifacts, wherein the one or more system requirements are presented in addition to the visual representation of the physical system.

3. The computing system of claim 1, wherein the plurality of MBSE artifacts comprise one or more of: structural diagrams, state machine diagrams, sequence diagrams, activity diagrams, requirements information, or parametric models.

4. The computing system of claim 1, wherein the instructions are executable by the one or more processors to configure the computing system to:
after receiving the user input directed to the particular label, present one or more component details for the respective physical component that corresponds to the particular 2D or 3D component, wherein the one or more component details are presented in addition to the visual representation of the physical system.

5. The computing system of claim 1, wherein each label of the plurality of labels is presented according to a respective hierarchy level within the MBSE hierarchy representation.

6. The computing system of claim 1, wherein the relational structure of the MBSE hierarchy representation comprises one or more visual links connecting one or more labels of the plurality of labels.

7. The computing system of claim 1, wherein the instructions are executable by the one or more processors to configure the computing system to:
receive user input directed to an additional label of the plurality of labels of the MBSE hierarchy representation; and
in response to receiving the user input directed to the additional label:
refrain from presenting the particular 2D or 3D component as emphasized within the presentation of the visual representation of the physical system; and
visually emphasize an additional 2D or 3D component of the plurality of 2D or 3D components within the presentation of the visual representation of the physical system, wherein the additional label corresponds to the additional 2D or 3D component.

8. The computing system of claim 1, wherein each label of a second set of labels of the plurality of labels corresponds to a respective component of the physical system not depicted in the visual representation.

9. The computing system of claim 8, wherein the set of labels and the second set of labels of the plurality of labels comprise different visual characteristics within the MBSE hierarchy representation.

10. The computing system of claim 1, wherein the instructions are executable by the one or more processors to configure the computing system to:
after receiving the user input directed to the particular label, modify the presentation of the particular to emphasize the particular label within the MBSE hierarchy representation.

11. The computing system of claim 1, wherein the physical system comprises a deployed system, and wherein the instructions are executable by the one or more processors to configure the computing system to:
present a selectable element for facilitating presentation of a maintenance interface; and
after receiving additional user input directed to the selectable element, present the maintenance interface, wherein the maintenance interface depicts one or more maintenance tasks for the deployed system.

12. The computing system of claim 1, wherein the visual representation further comprises one or more simulations associated with the physical system.

13. A computing system, comprising:
one or more processors; and
one or more computer-readable recording media that store instructions that are executable by the one or more processors to configure the computing system to:
present a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system;
receive user input directed to a particular 2D or 3D component of the plurality of 2D or 3D components of the visual representation; and
in response to receiving the user input directed to the particular 2D or 3D component, present a model-based systems engineering (MBSE) hierarchy representation in addition to the visual representation of the physical system, wherein the MBSE hierarchy representation comprises a plurality of labels, wherein each label of a set of labels of the plurality of labels corresponds to a respective 2D or 3D component of the plurality of 2D or 3D components of the visual representation, wherein the set of labels comprises a particular label corresponding to the particular 2D or 3D component, wherein the particular label is presented as emphasized within the MBSE hierarchy representation, wherein the MBSE hierarchy representation comprises a relational structure indicating one or more relationships among labels of the plurality of labels, wherein MBSE hierarchy representation depicts a relationship between the particular label and a higher-level label of the plurality of labels, and wherein the one or more relationships among the labels of the plurality of labels are defined by a plurality of MBSE artifacts of an MBSE model for the physical system.

14. The computing system of claim 13, wherein the instructions are executable by the one or more processors to configure the computing system to:
after receiving the user input directed to the particular 2D or 3D component, present one or more component details for the respective physical component that corresponds to the particular 2D or 3D component, wherein the one or more component details are presented in addition to the visual representation of the physical system.

15. The computing system of claim 13, wherein the instructions are executable by the one or more processors to configure the computing system to:
receive user input directed to an additional 2D or 3D component of the plurality of 2D or 3D components of the visual representation; and
in response to receiving the user input directed to the additional 2D or 3D component:
refrain from presenting the MBSE hierarchy representation; and
present an additional MBSE hierarchy representation in addition to the visual representation of the physical system, wherein the additional MBSE hierarchy representation comprises an additional plurality of labels, wherein each label of an additional set of labels of the additional plurality of labels corresponds to a respective 2D or 3D component of the plurality of 2D or 3D components of the visual representation, wherein the additional set of labels comprises an additional label corresponding to the additional 2D or 3D component, wherein the additional label is presented as emphasized within the additional MBSE hierarchy representation.

16. The computing system of claim 13, wherein the instructions are executable by the one or more processors to configure the computing system to:
after receiving the user input directed to the particular 2D or 3D component, modify the presentation of the visual representation to emphasize the particular 2D or 3D component.

17. The computing system of claim 13, wherein the user input directed to the particular 2D or 3D component comprises a first type of user input, and wherein the instructions are executable by the one or more processors to configure the computing system to:
after receiving a second type of user input directed to one or more 2D or 3D components of the visual representation, present a visual indication within the visual representation that the one or more 2D or 3D components comprise selectable components.

18. The computing system of claim 13, wherein the physical system comprises a deployed system, and wherein the instructions are executable by the one or more processors to configure the computing system to:
present a selectable element for facilitating presentation of a maintenance interface; and
after receiving additional user input directed to the selectable element, present the maintenance interface, wherein the maintenance interface depicts one or more maintenance tasks for the deployed system.

19. The computing system of claim 13, wherein the instructions are executable by the one or more processors to configure the computing system to:
receive additional user input directed to inspecting the particular 2D or 3D component; and
after receiving the additional user input, modify presentation of the particular 2D or 3D component to displace the particular 2D or 3D component relative to a next-higher assembly of the visual representation of the physical system.

20. A methods, comprising:
presenting a visual representation of a physical system, wherein the physical system comprises a plurality of physical components that are interconnected or that interoperate with one another, wherein the visual representation comprises a plurality of 2D or 3D components, and wherein each 2D or 3D component of the plurality of 2D or 3D components corresponds to a respective physical component of the plurality of physical components of the physical system;
presenting a model-based systems engineering (MBSE) hierarchy representation, wherein the MBSE hierarchy representation comprises a plurality of labels, wherein the MBSE hierarchy representation comprises a relational structure indicating one or more relationships among labels of the plurality of labels, wherein each label of a set of labels of the plurality of labels corresponds to a respective 2D or 3D component of the plurality of 2D or 3D components of the visual representation of the physical system, and wherein the one or more relationships among the labels of the plurality of labels are defined by a plurality of MBSE artifacts of an MBSE model for the physical system;
receiving user input directed to a particular label of the set of labels of the plurality of labels of the MBSE hierarchy representation, wherein the particular label corresponds to a particular 2D or 3D component of the plurality of 2D or 3D components of the visual representation of the physical system, wherein MBSE hierarchy representation depicts a relationship between the particular label and a higher-level label of the plurality of labels; and
in response to receiving the user input directed to the particular label, navigating to and visually emphasizing the particular 2D or 3D component within the presentation of the visual representation of the physical system.
